(19) United States
(12) Patent Application Publication
(10) Pub. No.: US 2018/0119619 A1
(43) Pub. Date: May 3, 2018

(54) GAS TURBINE ENGINE WITH BLEED SLOTS AND METHOD OF FORMING

(71) Applicant: PRATT & WHITNEY CANADA CORP., Longueuil (CA)

(72) Inventors: Guilherme WATSON, Toronto (CA); Bernard CHOW, Mississauga (CA)

(21) Appl. No.: 15/341,230

(22) Filed: Nov. 2, 2016

(51) Int. Cl. F02C 9/18; F01D 25/24; F01D 9/04

(52) U.S. Cl. CPC F02C 9/18; F05D 2220/32; F01D 9/041; F01D 25/24

(57) ABSTRACT

A gas turbine engine for an aircraft includes a compressor section where at least one of the airfoil members defines a vane exit vector extending tangentially from a curved surface of the airfoil member adjacent a trailing edge of the airfoil member, a projection of the vane exit vector in a longitudinal plane perpendicular to a radial direction of the engine extending at an airfoil angle from the longitudinal axis. A bleed slot defined through the casing wall and providing fluid communication between the core air passage and the bleed duct extends along a slot axis. A projection of the slot axis in the longitudinal plane extends at a slot angle with respect to the longitudinal axis. The slot angle is different from the airfoil angle. A method of forming bleed slots in a gas turbine engine is also discussed.

### TECHNICAL FIELD

The application relates generally to gas turbine engines and, more particularly, to bleed air flow in gas turbine engines.

### BACKGROUND

In some gas turbine aircraft engines, air is extracted from compressor stages and supplied to other parts of the engine or to other aircraft systems. Such air may be referred to as bleed air. Bleed air may, for example, be used for temperature control or to condition the fuel-air mixture in the combustor or turbine section of an engine. Alternatively or additionally, bleed air may be circulated to the wings for ice control or to cabin environmental control systems. In some aircraft, bleed air may be used for multiple purposes.

Aircraft systems may therefore require at least a minimum flow rate of bleed air at a particular temperature and pressure. Existing bleed air systems typically have slots which divert bleed air at an angle perpendicular to the main gas path through the engine. Such bleed slots may result in losses, which may in turn undermine flow efficiency and reduce temperature and pressure of bleed air.

### SUMMARY

In one aspect, there is provided a gas turbine engine for an aircraft, comprising: a core air passage; a compressor section comprising a rotor and a stator each having circumferentially-spaced airfoil members, the rotor rotatable about a longitudinal axis of the engine, at least one of the airfoil members defining an exit vector extending tangentially from a curved surface of the airfoil member adjacent a trailing edge of the airfoil member, a projection of the exit vector in a longitudinal plane perpendicular to a radial direction of the engine extending at an airfoil angle from the longitudinal axis; a bleed duct for routing air from the core air passage to aircraft systems; and a casing wall separating the bleed duct and the core air passage, the casing wall having a bleed slot defined therethrough providing fluid communication between the core air passage and the bleed duct, the bleed slot extending along a slot axis, a projection of the slot axis in the longitudinal plane extending at a slot angle with respect to the longitudinal axis, the slot angle being different from the airfoil angle.

In another aspect, there is provided a method of forming bleed slots in a gas turbine engine, comprising: numerically simulating an average direction of airflow in a region of a compressor section of the gas turbine engine using a numerical model; and creating a bleed slot through a casing of the gas turbine engine in the region of the compressor section, the bleed slot oriented so that in a plane perpendicular to a radial direction of the engine, the slot extends along the average direction of the airflow.

In a further aspect, there is provided a gas turbine engine for an aircraft, comprising: a compressor section defining a core air passage; a bleed duct for routing air from the core air passage to aircraft systems; and a casing wall separating the bleed duct and the core air passage, the casing wall having a bleed slot defined therethrough providing fluid communication between the core air passage and the bleed duct, the bleed slot extending along a slot axis; wherein the slot axis is aligned with an average airflow in the core air passage proximate an inlet of the bleed slot at a predetermined operating condition of the engine.

### DESCRIPTION OF THE DRAWINGS

In the figures, which depict example embodiments:

FIG. 1 is a schematic cross-sectional view of a gas turbine engine;

FIG. 2 is an enlarged schematic cross-sectional view of a compressor section of the engine of FIG. 1, according to a particular embodiment;

FIG. 3 is a partial enlarged schematic view of a rotor and stator of the compressor section of FIG. 2, viewed in a plane perpendicular to a radial direction;

FIG. 4 is an enlarged schematic view of the stator of FIG. 3, showing airflow and pressure contours;

FIG. 5 is a partial schematic tridimensional view of the stator of FIG. 4;

FIGS. 6A and 6B are schematic top and side views of part of the casing and stator of the compressor section of FIG. 2;

FIGS. 7A, 7B and 7C are schematic front, bottom and side views, of bleed slots and stator vanes of the stator and casing of FIGS. 6A-6B;

FIG. 7D is a schematic top view showing bleed slots overlaid on the pressure contour distribution of FIG. 4, in accordance with a particular embodiment;

FIG. 8A is a schematic tridimensional view of the casing of FIGS. 7A-7C, showing bleed slots;

FIG. 8B is an enlarged schematic tridimensional view of part of the casing of FIG. 8A;

FIG. 8C is an enlarged schematic front view of a portion of the casing of FIG. 8A; and

FIG. 9 is a flow chart showing a process of creating bleed slots.

### DETAILED DESCRIPTION

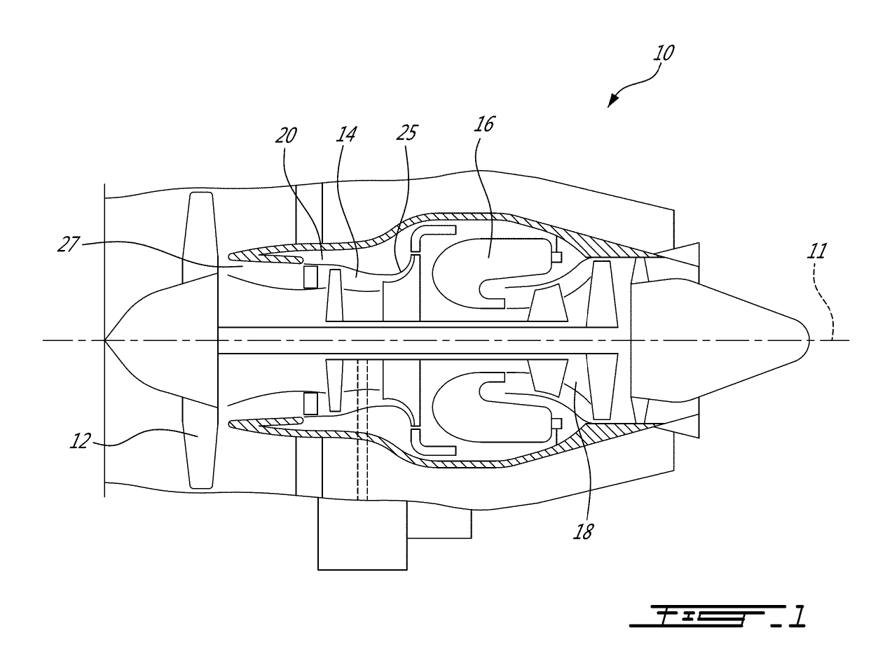

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

Gas turbine engine 10 provides propulsion to an aircraft. Gas turbine engine 10 may also have additional functions. For example, gas turbine engine 10 may provide a supply of pressurized air, which may be referred to as bleed air, to other aircraft systems. Bleed air may be drawn from compressor section 14 and fed to aircraft systems through a bleed duct 20. Bleed air may, for example, be used for cooling in engine combustor section 16 or turbine section 18, or as a heat source, for example, for cabin environmental controls, anti-icing systems or the like.

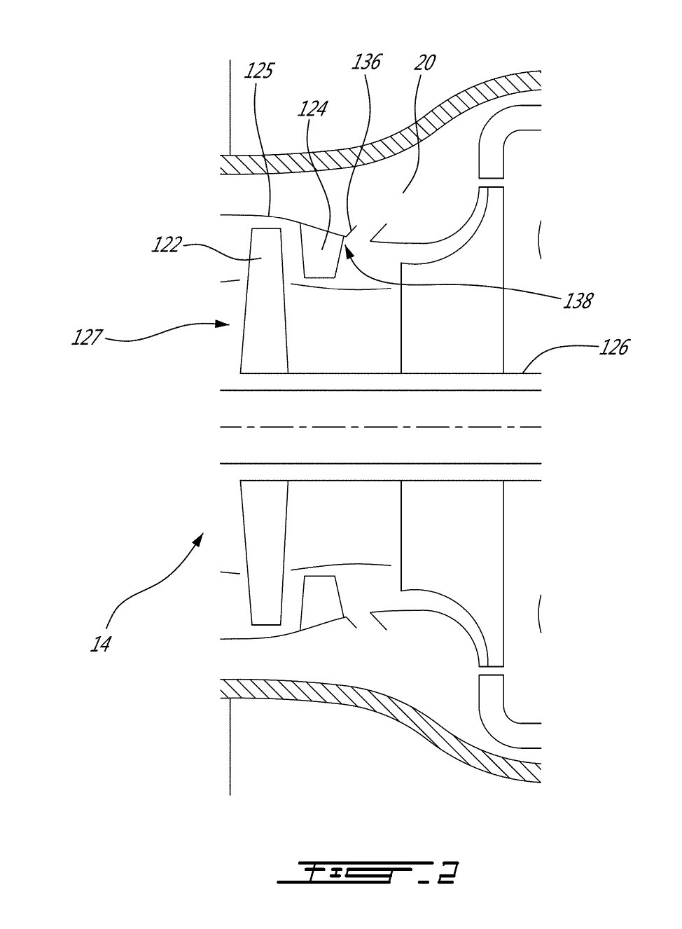

FIG. 2 depicts the compressor section 14 in greater detail, in accordance with a particular embodiment. Compressor section 14 has one or more rotor(s) 122 and stator(s) 124 which are serially-arranged, and a casing 125 defining an annular core air passage 127. Each rotor 122 is mounted for rotation on shaft 126 and each stator 124 is stationary.

Each rotor 122 and stator 124 has a plurality of airfoil members (stator vanes 130, rotor blades 131) spaced around its circumference and extending in the core air passage 127. The vanes and blades 130, 131 are configured so that rotation of the rotors 122 draws air from fan 12 and forces it along annular passage 127. Rotation of rotor(s) 122 accelerates air and increases its dynamic pressure and temperature.

Compressor section 14 has one or more bleed slots 136 through which annular passage 127 communicates with bleed duct 20 to admit bleed air into the bleed duct 20. As air passes into bleed duct 20, it is decelerated and kinetic energy is recovered as static pressure. In the embodiment shown, the bleed slots 136 are spaced circumferentially around casing 125 and are located at least in part immediately downstream of the vanes 130 of the stator 124. It is understood that the bleed slots 136 may alternately be located in any other location where bleed is required, including, but not limited to, completely or partially between stator vanes 130 and rotor blades 131.

Bleed slots 136 are sized to admit a desired quantity of air (e.g. a desired mass flow rate) into bleed duct 20. The desired quantity may depend on pressure requirements of aircraft systems. The desired mass flow rate may be for example measured as a % of the total flow through the core passage 127; for example, in a particular embodiment, the bleed slots 136 are sized to admit 9% of the mass flow at the inlet of the core passage 127. Other values are also possible.

Some prior compressor sections include bleed slots which extend perpendicularly to the outer wall of the casing 125, i.e., aligned with the radial direction. As it flows from annular passage 27 into the bleed slots, bleed air is redirected to a direction aligned with bleed slots, i.e. perpendicularly to the wall of the casing 125. Such diversion of air may cause losses due, for example, to friction, turbulence and flow separation. Accordingly some energy is lost, rather than being recovered as static pressure. Diversion of bleed air into bleed slots may also cause disturbances within annular passage 27.

The amount of energy lost and the amount of flow disturbance caused as bleed air flows into bleed slots may depend on factors such as the size of the angle between flow in annular passage 27 and the orientation of bleed slot, the pressure of air in annular passage 27 and the quantity of bleed air flowing through bleed slot. With perpendicular bleed slots, the angle between the bleed slots and the average flow of air in annular passage 27 is relatively large. Accordingly, losses due to diversion of air into bleed slots may be significant.

By contrast and as shown in FIG. 2, the bleed slots 136 are aligned with the flow of air through core passage 127 at inlets 138 of the bleed slots 136. As depicted, inlets 138 are positioned at regions of high pressure in core passage 127, proximate trailing edge 134 of stator vanes 130. Other locations are alternately possible, including, but not limited to, locations of high flow pressure.

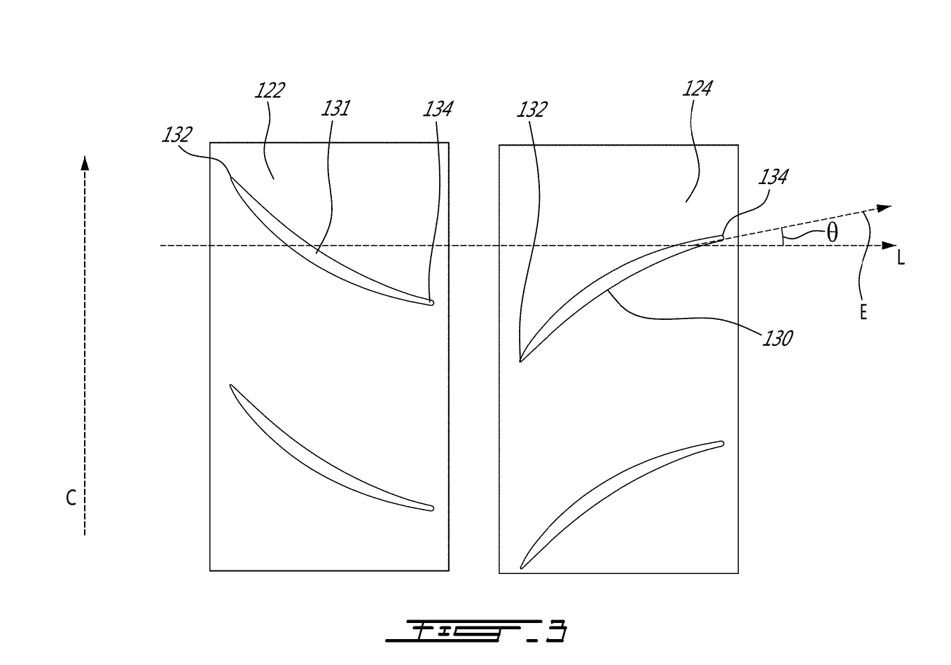

As shown in FIG. 3, each airfoil member 130, 131 has an airfoil shape, with a respective leading edge 132 and a trailing edge 134 located downstream of the leading edge 132. As used herein, the terms “upstream” and “downstream” refer to the general direction of the flow through the engine 10. Specifically, the general direction of the flow is from left to right in FIG. 3.

As rotor 122 turns, rotor blades 131 are moved circumferentially as indicated by arrow C. Rotor blades 131 act on air within annular passage 127, accelerating the air and forcing the air along the blade's surface and downstream through annular passage 127. Air is likewise redirected along the surface of vanes 130 as it flows through stators 124.

Air approaches leading edges 132 of rotor blades 131 and stator vanes 130 with a velocity having an axial component, namely a component in the fore-to-aft direction along longitudinal axis L. In addition, airflow may have a circumferential component, namely, a component in the circumferential direction C causing airflow to have a curved (e.g. helical) path through passage 127 and, possibly, a radial component, namely, a component in a radial direction of rotors 122, stators 124.

As rotor blades 131 act on the air, the velocity increases. In particular, the circumferential component may change in proportion to the speed of rotor blades 131.

Air travelling over airfoil members 130, 131 generally follows the profile of the airfoil member 130, 131. That is, air entering contact with airfoil members 130, 131 is initially directed toward a path aligned with the profile of airfoil members 130, 131 proximate leading edge 132, and is turned toward a path aligned with the profile of airfoil members 130, 131 proximate trailing edge 134. Thus, the profile of each airfoil member 130, 131 (in the embodiment shown, each stator vane 130) defines an exit vector E tangential to the airfoil member 130, 131 near its trailing edge, along which airflow would exit airfoil member 130, 131 under ideal conditions.

The stator vanes 130 and rotor blades 131 have a curved profile, and proximate trailing edge 134 forms an angle with respect to the longitudinal axis L. In the plane of FIG. 3, which is defined perpendicularly to the radial direction, the projection of the exit vector E extends at an airfoil angle a with respect to the longitudinal axis L. Under ideal conditions, airflow would exit the stator vanes 130 along a path aligned with this airfoil angle θ. However, in operation, flow typically diverges from the ideal path.

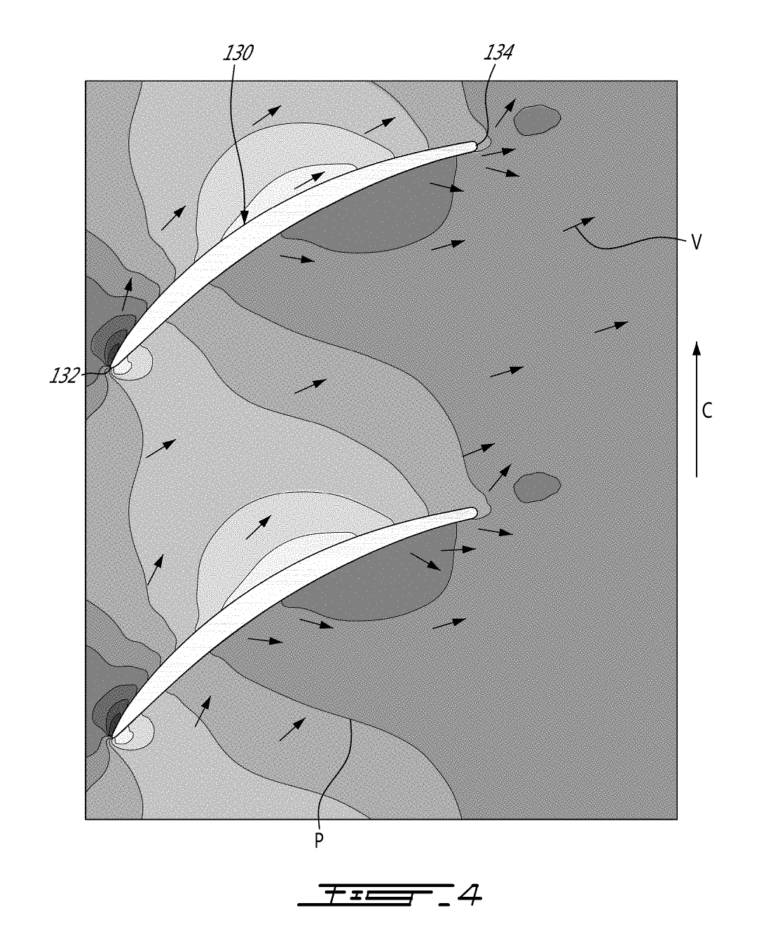

FIG. 4 depicts a radial view of air flow within passage 127 around stator vanes 130. Contour lines P in FIG. 4 denote regions of static pressure, with darker regions corresponding to higher pressures. Arrows V denote the direction of flow of the air (air velocity vector) at locations within passage 127. Air exiting stator 124, i.e. air proximate a trailing edge 134 of a vane 130, may have higher static pressure than air proximate leading edge 132.

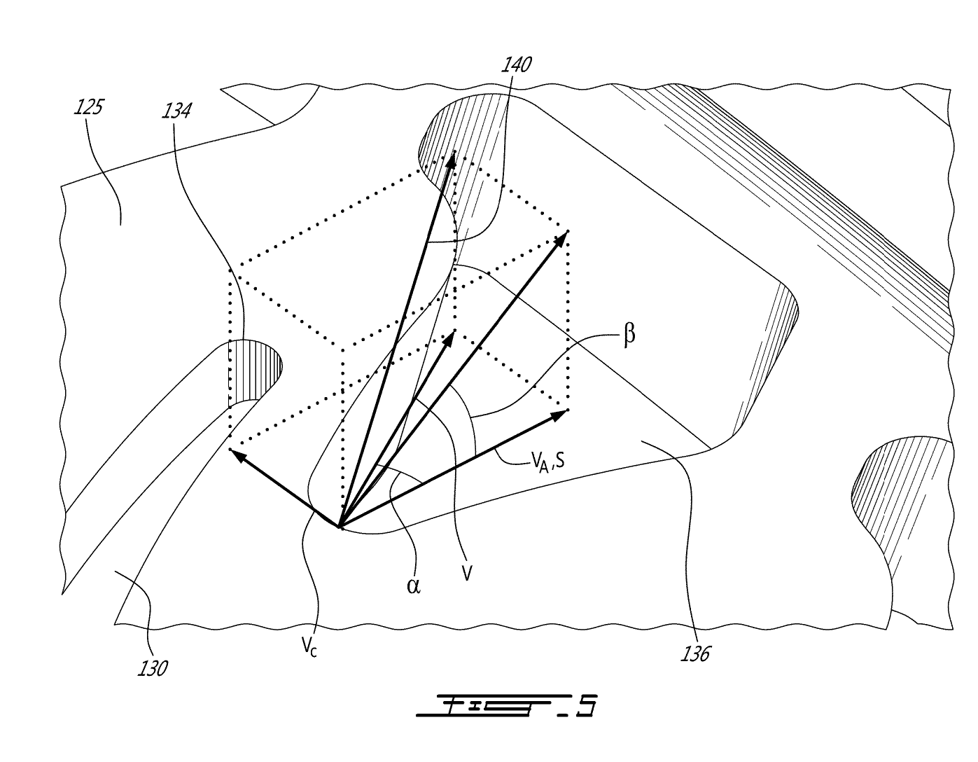

FIG. 5 depicts a partial perspective view of a stator 124, illustrating components of air velocity in passage 127. Air velocity V includes axial component V_{A} parallel to longitudinal axis L (FIG. 3) and circumferential component V_{c} in the circumferential direction C (FIG. 3), extending tangentially to the circle defined by blades 131 of the rotor 122 upon rotation, i.e. tangentially to the annular wall of the casing 125.

The magnitude and direction of air velocity V may vary at different locations within passage 127 and over time. For example, perturbations may be present and velocity may change as air flows over an airfoil member 130, 131. Therefore, air velocity may be represented by an average value at a particular location.

As noted and referring back to FIG. 2, in a particular embodiment bleed slots 136 are positioned proximate trailing edges 134 of vanes 130 of the stator 124. That is, inlets 138 of the bleed slots 136 are positioned on casing 125 near trailing edges 134 of the vanes 130 of the stator 124. Bleed slots 136 are aligned with the air flow in those locations. Accordingly, each bleed slot extends in a direction with an axial component along the longitudinal direction L and a component along the circumferential direction C.

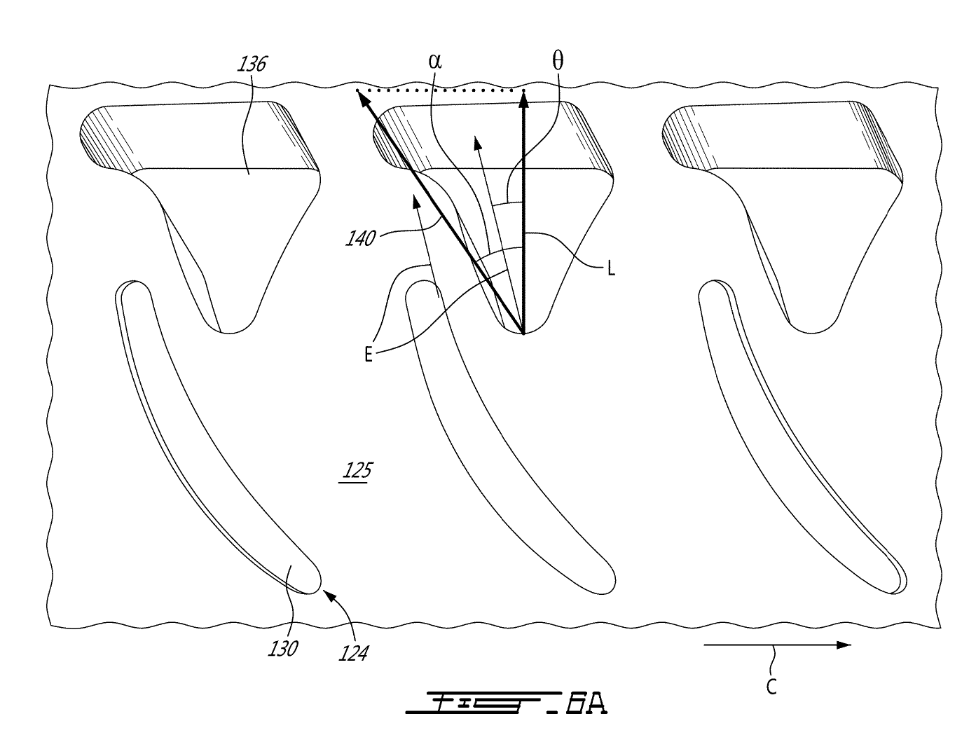

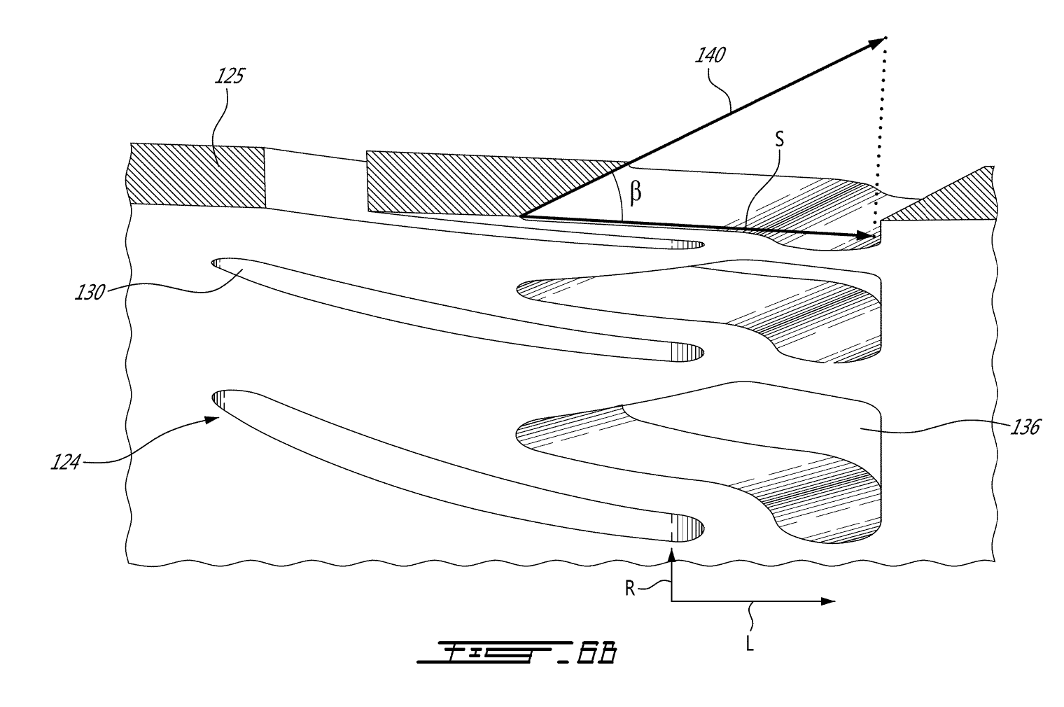

FIGS. 6A, 6B depict top and side views of the stator 124, casing 125 and bleed slot 136, showing the orientation of bleed slot 136. For simplicity, only a single bleed slot 136 is depicted. However, as noted, a plurality of bleed slots may be present, for example, spaced circumferentially apart from one another around casing 125.

Specifically, bleed slot 136 extends along a slot axis 140. FIGS. 6A, 6B show projections of slot axis 140 onto two different longitudinal planes of compressor section 14, which are orthogonal to one another. The longitudinal plane of FIG. 6A extends perpendicularly to the radial direction R (see FIG. 6B) at the bleed slot 136, and contains the longitudinal direction L and the circumferential direction C. The longitudinal plane of FIG. 6B extends perpendicularly to the circumferential direction C at the bleed slot 136 and contains the longitudinal direction L and the radial direction R.

As shown in FIG. 6A, a projection of the slot axis 140 into the longitudinal plane perpendicular to the radial direction forms a first slot angle a (see also FIG. 5) relative to the longitudinal direction L. As shown in FIG. 6B, a projection of slot axis 140 into the longitudinal plane perpendicular to the circumferential direction forms a second slot angle or lean angle β (see also FIG. 5) relative to local shroud direction S, defined by the orientation of the wall of the casing 125; the local shroud direction S may be parallel to the longitudinal direction L, or extend at a non-zero angle with respect thereto.

Referring back to FIG. 6A, the first slot angle a approximates the average flow direction of air leaving airfoil member, e.g. stator vanes 130; in a particular embodiment, the first slot angle α corresponds to the average swirl angle of the flow at a particular operating condition where a predetermined bleed flow is required. The first slot angle α thus differs from the airfoil angle θ defined by vane 130 at its trailing edge 134, by an amount reflecting the deviation of the flow from the vane 130. The difference between the airfoil angle θ and the angle of the flow (e.g. swirl angle) may depend on, for example, rotational speed of the engine, or on the velocity (e.g. the longitudinal velocity) of incoming airflow. In particular, the difference between the airfoil angle θ and the angle of the flow may be proportional to incoming airflow velocity and inversely proportional to engine rotational speed. Thus, during operation, the difference between the airfoil angle θ and the angle of flow varies along with engine speed, and may be smaller closer to the design speed (e.g. high altitude cruise). The difference between the airfoil angle θ and the first slot angle α thus depends on the operating conditions selected to optimise the bleed through the bleed slots.

Although not shown, the airfoil angle θ and the first slot angle α can be similarly defined for bleed slots positioned adjacent rotor blades 131.

First slot angle α of bleed slot 136 may therefore be configured to provide desired performance at a particular range of operating conditions, that is, to align with average flow during that range of engine operating conditions based on the expected flow direction. The first slot angle α can have any suitable value between −90 degrees to +90 degrees with respect to the longitudinal axis, depending on the angle of the flow. The first slot angle α can be greater or smaller than the airfoil angle θ of the adjacent airfoil member. In a particular embodiment where the adjacent airfoil member is a stator vane 130 and the bleed slot is positioned near its trailing edge, the first slot angle α is greater than the airfoil angle θ of the vane 130; in another particular embodiment where the adjacent airfoil member is a rotor blade 131 and the bleed slot is positioned near its trailing edge, the first slot angle α is smaller than the airfoil angle θ of the blade 131.

In a particular embodiment, the first slot angle α corresponds to the swirl angle of the flow for ground idle conditions. In another particular embodiment, the first slot angle α corresponds to the swirl angle of the flow for a rotational speed of the engine lower than ground idle speed.

In a particular embodiment, the difference between the first slot angle α and the airfoil angle θ of the adjacent airfoil member has an absolute value corresponding to any one or any combination of the following: at least 1 degree; at least 5 degrees; at least 10 degrees; 20 degrees or less. Other values are also possible.

Referring back to FIG. 6B, second slot angle or lean angle β is an angle at which bleed slot 136 diverges from the main annular gas flow path 127 defined by casing 125. Reduction of the lean angle β reduces the amount by which airflow must be diverted in order to flow into and through bleed slot 136, which may correspondingly reduce losses and increase the amount of energy recovered as static pressure in bleed duct 20. However, reduction of lean angle β may tend to reduce the quantity of air that is diverted from passage 127 into bleed duct 20 through bleed slot 136, depending on the length of the passage and size of the opening. For example, for a long and narrow passage, the quantity of bled air may be reduced if the lean angle β is reduced, because of a reduction in throat area; however, the bleed flow through a short and wide passage may not be affected by a reduction of lean angle β. In some embodiments, lean angle β is greater than 20 degrees and less than 90 degrees. In some preferred embodiments, lean angle β may be between 20 and 60 degrees. In other preferred embodiments, lean angle β may be between 25 and 35 degrees. Such configurations may be particularly suitable for maximizing pressure in bleed duct 20 during engine start-up conditions.

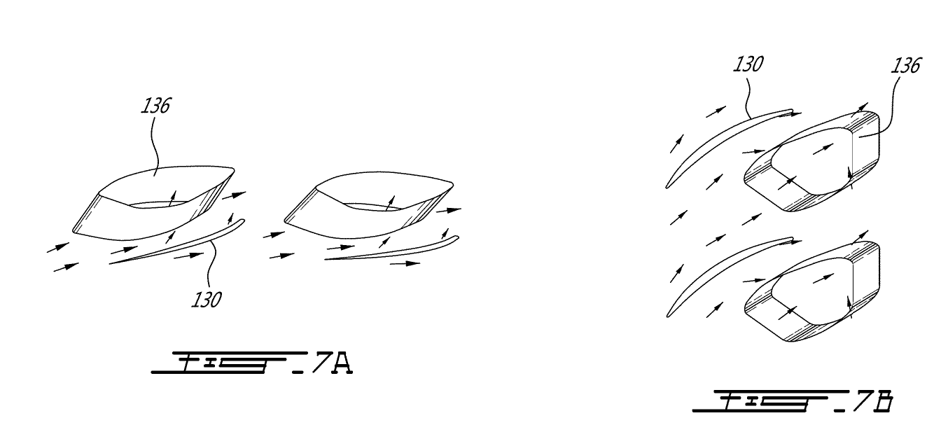

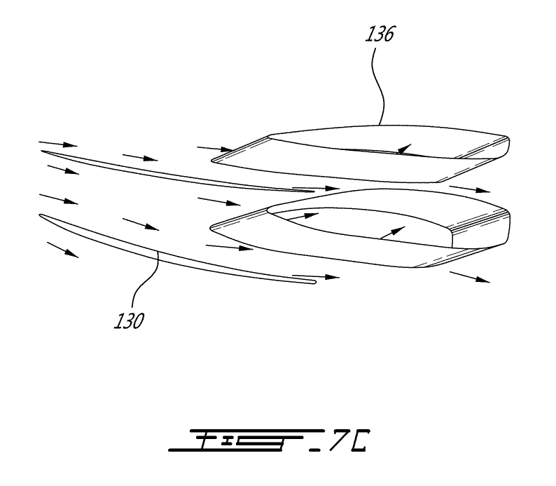

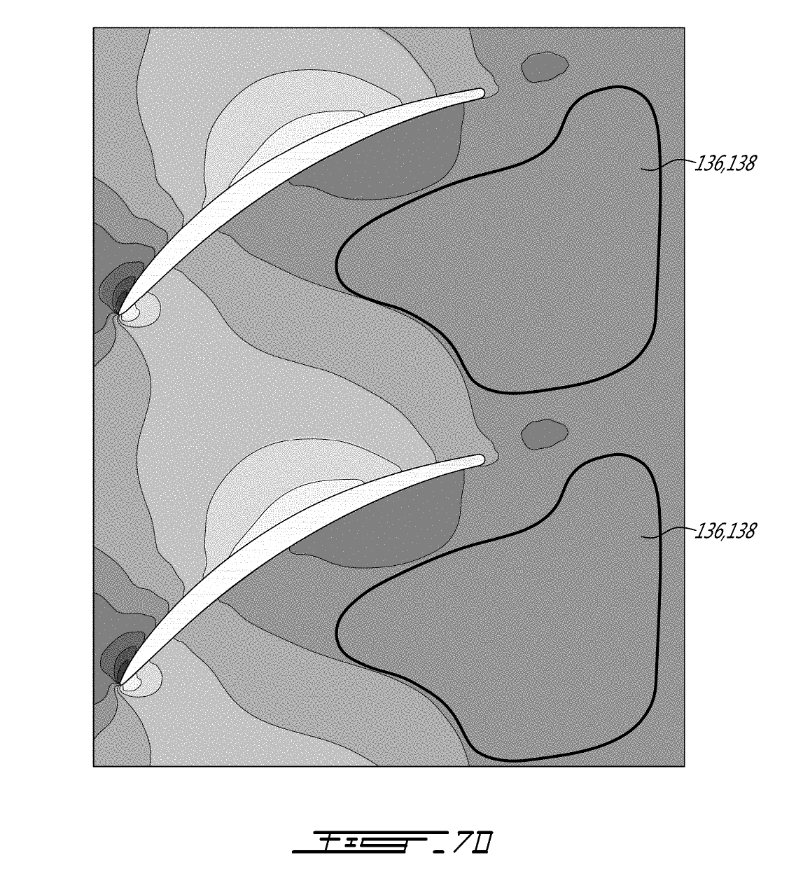

FIGS. 7A, 7B and 7C depict front, top and side views, respectively, of air flow through vanes 130, showing example bleed slots 136, and FIG. 7D shows examples of bleed slots 136 overlaid on the pressure contour lines P of FIG. 4. Arrows V in FIGS. 7A-7C indicate the direction of airflow. Contour lines P in FIG. 7D denote static pressure, with lighter regions indicating higher pressures. As depicted, bleed slots 136 are positioned with their inlets 138 in regions of high pressure. In the depicted embodiment, such high-pressure regions are located near the downstream portions of vanes 130 and downstream of the trailing edges 134 of vanes 130. In other embodiments, static pressure distribution may differ.

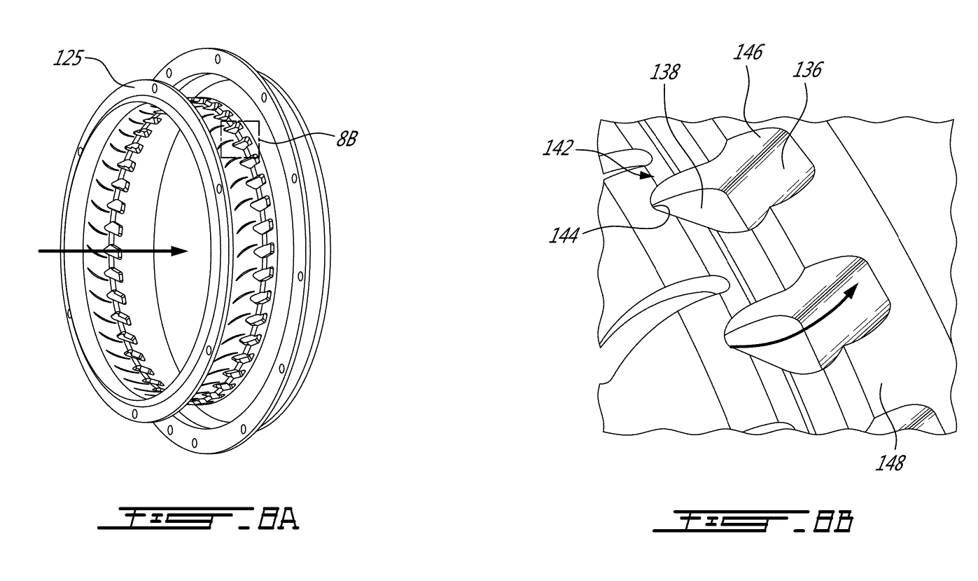

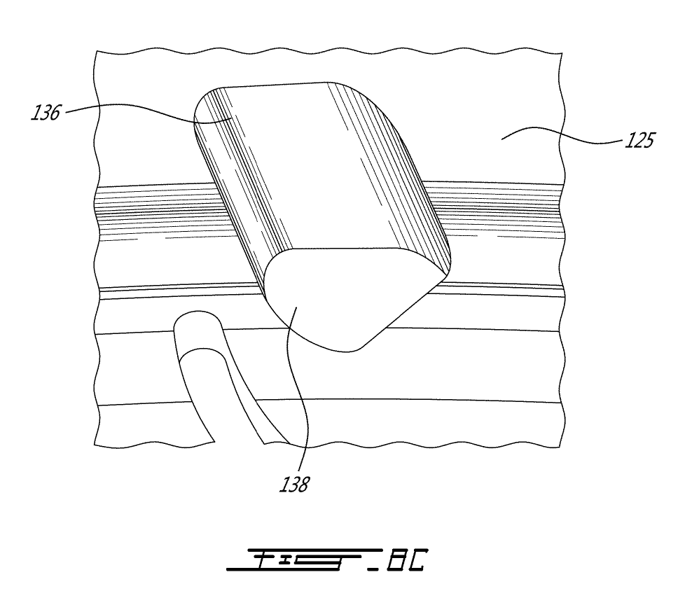

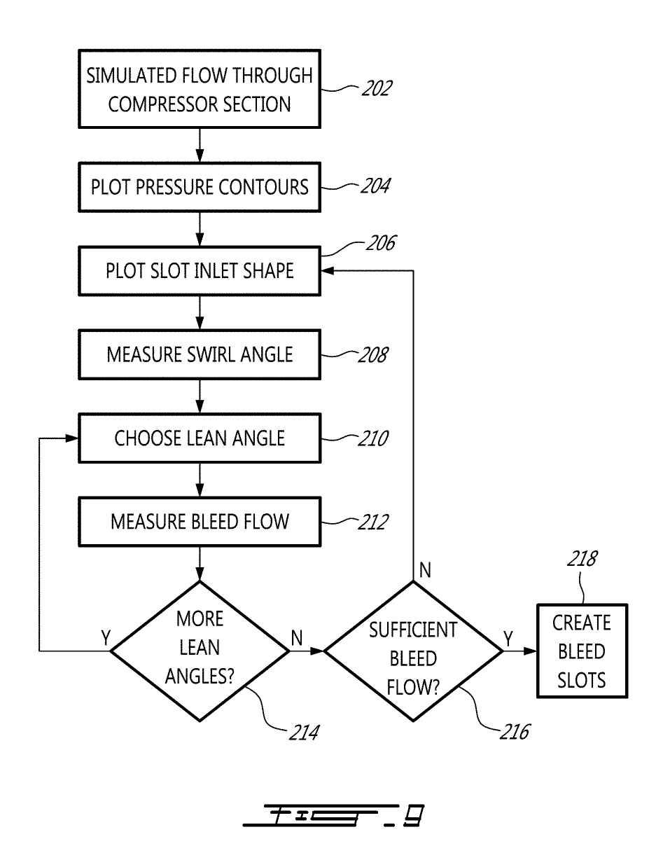

Inlets 138 may be configured to promote or maximize air inflow relative to inlet area and flow losses. For example, as shown in FIGS. 8A-8C, inlets 138 may have a generally triangular shape with downstream diverging edges. The shape of inlets 138 may be selected to correspond at least in part to contours of high-pressure regions in passage 127 during operation.

As can be best seen in FIG. 8B, the walls 142 of the bleed slots 136 are defined by the wall of the casing 125 through which the slots 136 are formed. Walls 142 may define upstream surfaces 144 and downstream surfaces 146. Walls 142 may extend in a direction generally approximately parallel to slot axis 140. Alternatively, walls 142 may converge or diverge.

As depicted in FIGS. 8A-8C, walls 142, 144 are of uniform height. However, in some embodiments, downstream walls 144 may extend farther into bleed duct 20 than upstream walls 142. Downstream walls 144 may be principally responsible for redirecting bleed air from its path in passage 127 into and through bleed slots 136. Accordingly, the angle at which downstream walls 144 extend may have a significant effect on flow losses. In particular, flow losses may be limited when downstream walls 144 align with the flow. Upstream walls 142 may have a proportionally smaller impact on flow losses and may therefore be shorter or may not be aligned with the flow. Accordingly, in some embodiments the downstream walls 144 are aligned at the slot angles α, β as described above.

In a particular embodiment, the bleed slots 136 are formed by milling casing 125 from its inside surface; the casing wall may be relatively thin, for example have a thickness of 0.080 inches. Such milling may be performed using a tool oriented along the desired slot axis 140. Manufacturing of the bleed slots 136 may cause a rim or flange to be extruded from casing 125, extending outwardly from casing 125, parallel to slot axis 140.

In some embodiments and as can be seen in FIGS. 8A-8B, casing 125 has an annular ridge 148 located at the downstream side of bleed slots 136. Annular ridge 144 may be a region of increased casing thickness, and may project radially outwardly from the outside wall of casing 125 inside the bleed duct 20. Ridge 125 may promote flow of bleed air through slots 136.

Pressures and velocities within passage 127 may be determined by modeling, such as analytical or numerical modeling. For example, flow conditions such as pressures and velocities may be determined using a numerical simulation in a software package such as ANSYS CFX. Any other suitable numerical simulation software may alternately be used.

FIG. 9 shows an example process 200 for forming a bleed slot. At block 202, a numerical model of compressor section 14 is constructed. Using the numerical model, airflow through compressor section 14 is simulated at one or more engine operating conditions. For example, airflow may be simulated under engine start-up conditions and/or ground idle conditions.

The simulation performed at block 202 may include calculations of pressure and air velocity throughout core passage 127. At block 204, pressure contours are plotted, as depicted in FIG. 4. At block 206, a shape and location of bleed slot inlet 138 is determined. Specifically, bleed slots 136 may be located based on the location of high pressure regions and the shape of the slot inlets 138 may be designed to correspond at least in part to contours of high pressure regions. As shown in FIG. 7D, high pressure regions are located proximate trailing edges 134 in a particular embodiment. However, in other embodiments, the location of high-pressure regions and inlets 138 may differ.

At block 208, the simulation created at block 202 is used to measure airflow velocity proximate the locations of inlets 138. An average velocity is taken in the vicinity of inlets 138 and the airflow angle (swirl angle) is measured, being the angle between the average velocity vector and the longitudinal axis L. As noted above, the swirl angle differs from the airfoil angle θ defined by the airfoil member trailing edge 134.

At block 210, a lean angle β is chosen for evaluation. The numerical model of compressor section 14 is modified to include bleed slots 136 having bleed axes 140 extending at the first slot angle α corresponding to the measured swirl angle and at the chosen lean angle β.

At block 212, airflow through compressor section 14 is simulated with the modified numerical model including bleed slots 136. Flow into bleed duct 20 and pressure in bleed duct 20 are measured.

Multiple lean angles β may be evaluated as candidates for a final design. For example, lean angles β may be evaluated in fixed increments (e.g. 5 degrees) from a minimum threshold (e.g. 20 degrees) to a maximum threshold (e.g. 60 degrees). Other values are also possible.

After a lean angle β is evaluated at block 212, if more lean angles β remain to be evaluated, the process returns to block 210, and another lean angle β is selected for evaluation.

If there are no further lean angles β to be evaluated, at block 214, the bleed flow measured for each lean angle β may be compared to a performance threshold (e.g. target mass flow of bleed) to determine if any of the lean angles β produce sufficient bleed flow. If none of the lean angles β produce sufficient bleed flow, the process returns to block 206 and the area of inlets 138 is increased.

If one or more of the evaluated lean angles β results in sufficient bleed air flow, one of those lean angles β is selected for a final design. The selection may depend on performance criteria. For example, in some embodiments, it may be desired to maximize bleed air flow or bleed air pressure. In other embodiments, it may be desired to provide at least a threshold amount of bleed air flow or pressure, with the least disturbance to flow within passage 127.

As described above and in a particular embodiment, bleed slots 136 are positioned proximate trailing edges 134 of a stage of stator vanes 130. That is, the bleed slots 136 are located proximate the downstream portion of a stator and immediately downstream of the stator 124. Bleed slots 136 and bleed slot inlets 138 may alternatively or additionally be positioned downstream of and proximate the downstream portion of a rotor 122.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A gas turbine engine for an aircraft, comprising:
a core air passage;
a compressor section comprising a rotor and a stator each having circumferentially-spaced airfoil members, the rotor rotatable about a longitudinal axis of the engine, at least one of the airfoil members defining an exit vector extending tangentially from a curved surface of the airfoil member adjacent a trailing edge of the airfoil member, a projection of the exit vector in a longitudinal plane perpendicular to a radial direction of the engine extending at an airfoil angle from the longitudinal axis;
a bleed duct for routing air from the core air passage to aircraft systems; and
a casing wall separating the bleed duct and the core air passage, the casing wall having a bleed slot defined therethrough providing fluid communication between the core air passage and the bleed duct, the bleed slot extending along a slot axis, a projection of the slot axis in the longitudinal plane extending at a slot angle with respect to the longitudinal axis, the slot angle being different from the airfoil angle.

2. The gas turbine engine of claim 1, wherein a projection of the slot axis in a second longitudinal plane perpendicular to a circumferential direction of the engine extends at a lean angle with respect a direction defined by the casing wall.

3. The gas turbine engine of claim 2, wherein the lean angle is between 20 and 60 degrees.

4. The gas turbine engine of claim 3, wherein the lean angle is between 25 and 35 degrees.

5. The gas turbine engine of claim 1, wherein the bleed slot is one of a plurality of the bleed slots, each aligned at least in part with one of the airfoil members of the stator.

6. The gas turbine engine of claim 1, wherein the bleed slot is one of a plurality of the bleed slots, each aligned at least in part with one of the airfoil members of the rotor.

7. The gas turbine engine of claim 1, wherein the bleed slot has an inlet positioned proximate a trailing edge of one of the airfoil members.

8. The gas turbine engine of claim 7, wherein the inlet has a shape corresponding to a high-pressure region in the core air passage.

9. The gas turbine engine of claim 1, wherein the casing wall comprises an outwardly-extending annular ridge disposed at a downstream edge of the bleed slot, the bleed slot partially defined through the annular ridge.

10. The gas turbine engine of claim 1, wherein a difference between the airfoil angle and the slot angle an absolute value of up to 20 degrees.

11. The gas turbine engine of claim 1, wherein the slot angle corresponds to an average swirl angle of a flow through the core air passage adjacent the bleed slot at a predetermined operating condition of the gas turbine engine.

12. A method of forming bleed slots in a gas turbine engine, comprising:
numerically simulating an average direction of airflow in a region of a compressor section of the gas turbine engine using a numerical model; and
creating a bleed slot through a casing of the gas turbine engine in the region of the compressor section, the bleed slot oriented so that in a plane perpendicular to a radial direction of the engine, the slot extends along the average direction of the airflow.

13. The method of claim 12, further comprising modifying the numerical model to include a model of the bleed slot extending along the average direction of the airflow and extending away from a main flow passage of the engine at a lean angle in a second longitudinal plane perpendicular to a circumferential direction of the engine, and wherein the bleed slot is created with an orientation corresponding to that of the model of the bleed slot.

14. The method of claim 13, comprising constructing a plurality of modified numerical models, each including a model of the bleed slot extending at one of a plurality of candidate lean angles, and simulating airflow through the compressor section with each modified numerical model, and wherein the bleed slot is created with an orientation corresponding to that of the model of the bleed slot having a selected one of the candidate lean angles.

15. The method of claim 13, further comprising measuring bleed flow characteristics using the modified numerical model.

16. The method of claim 12, comprising plotting pressure contours in the compressor section using the numerical model, wherein the slot is created with an inlet located in a region of high pressure of the pressure contours.

17. The method of claim 12, wherein numerically simulating the average direction of airflow is performed for a rotational speed of the engine corresponding to at most a rotational speed at ground idle conditions.

18. The method of claim 13, comprising measuring bleed flow using the numerical model and increasing an inlet size of the bleed slot if the bleed flow is less than a threshold value.

19. The method of claim 12, wherein numerically simulating the average direction comprises:
constructing the numerical model of the gas turbine engine;
numerically simulating the average direction of airflow in the region of the compressor section of the gas turbine engine using the numerical model;
measuring the average direction of airflow in the region of the compressor section.

20. The method of claim 12, wherein the region is a vane trailing edge region proximate an outer shroud of the compressor section.

21. A gas turbine engine for an aircraft, comprising:
a compressor section defining a core air passage;
a bleed duct for routing air from the core air passage to aircraft systems; and
a casing wall separating the bleed duct and the core air passage, the casing wall having a bleed slot defined therethrough providing fluid communication between the core air passage and the bleed duct, the bleed slot extending along a slot axis;
wherein the slot axis is aligned with an average airflow in the core air passage proximate an inlet of the bleed slot at a predetermined operating condition of the engine.
